(19) United States
(12) Patent Application Publication
(10) Pub. No.: US 2005/0247387 A1
(43) Pub. Date: Nov. 10, 2005

(54) Bicycle protective cover

(76) Inventors: Leonard G. Hooker, Galloway, NJ (US); Twanda L. Hooker, Galloway, NJ (US)

Correspondence Address: STEVEN HOROWITZ, ESQ., 295 MADISON AVE, SUITE 700, NEW YORK, NY, 10017, US

(21) Appl. No.: 10/838,548

(22) Filed: May 4, 2004

(51) Int. Cl. B65D 85/00; B62B 1/04

(52) U.S. Cl. 150/167

(57) ABSTRACT

A bicycle protective cover is used to protect the bicycle from the elements. It includes at least one pair of horizontal zippers situated near the crossbar of the bicycle and preferably two such pairs one near the front and one near the rear of the crossbar. It includes at least one pair of diagonal zippers situated near the bicycle wheels and preferably two such pairs one near the front wheel and one near the rear wheel. The front diagonal zipper pair is situated near where the front wheel meets the fork. The rear diagonal zipper pair is situated near where the rear wheel meets the bicycle gears. The zippers in each pair of zippers are aligned with one another so that locking devices can be inserted through the entire width of the cover.

### FIELD OF THE INVENTION

The present invention relates generally to bicycle covers and more specifically it relates to a bicycle protective cover for protecting the bicycle from the elements.

### DESCRIPTION OF THE PRIOR ART

Bicycle covers have been in use for years. Typically, waterproof material is utilized to cover a bicycle while protecting it from the elements. The problem with the waterproof material utilized within conventional bicycle covers is that the waterproof material is not easily secured about the bicycle so the task is tedious and the wind usually blows the material off the bicycle. The waterproof material utilized within conventional bicycle covers is not able to cover the entire bicycle while the bicycle is locked up or attached to a mounting frame on a vehicle because the locking chain interferes with the cover. In addition, the bicycle could not be secured or moved without having to take off the waterproof material.

Examples of patented bicycle covers include U.S. Pat. No. 3,968,913 to Weed atal. Other examples include U.S. Pat. No. 5,676,288 to Spirk; U.S. Pat. No. 361,977 to Kahler; U.S. Pat. No. 373,753 to Ferguson; U.S. Pat. No. 393,445 to Nicholson; U.S. Pat. No. 5,445,200 to Celestino et al.; U.S. Pat. No. 341,552 to Schardt; U.S. Pat. No. 5,372,169 to Norton et al.; U.S. Pat. No. 5,282,502 to Ballard; U.S. Pat. No. 5,193,724 to Robbins; U.S. Pat. No. 4,944,340 to Tortorich; U.S. Pat. No. 4,715,646 to Goffi et al.; U.S. Pat. No. 4,598,725 to Brewer and U.S. Pat. No. 4,356,831 to Adamsare, which are illustrative of the prior art.

While these devices may be suitable for the particular purpose to which they address, they are not suitable for being attached to a mounting frame on a vehicle or for secure locking of a bicycle.

The problem with the waterproof material used in the prior art is that the waterproof material could not easily be secured so the task to try to do so was a tedious one. In fact the wind usually blew the material off the bicycle. The waterproof material was not able to cover the entire bicycle while the bicycle was locked up or attached to a mounting frame on a vehicle. The bicycle could not be secured or moved without having to take off the waterproof material.

In these respects, the bicycle protective cover according to the present invention substantially departs from the conventional concepts and designs of the prior art, and in doing so provides an apparatus primarily developed for the purpose of protecting the bicycle from the elements while being securely locked to a pole or attached to a mounting frame on a vehicle.

### SUMMARY OF THE PRESENT INVENTION

In view of the foregoing disadvantages inherent in the known types of bicycle covers now present in the prior art, the present invention provides a new bicycle protective cover construction wherein the same can be utilized for protecting the bicycle from the elements.

The general purpose of the present invention, which will be described subsequently in greater detail, is to provide a new bicycle protective cover that has many of the advantages of the bicycle covers mentioned heretofore and many novel features that result in a new bicycle protective cover which is not anticipated, rendered obvious, suggested or even implied by any of the prior art bicycle covers, either alone or in combination.

To attain this, the present invention generally provides a cover having at least one pair of zippers within for allowing locking chains or similar devices to be inserted through and for tightening the cover about the bicycle. The zippers include a pair of horizontal zippers located near the bicycle crossbar and a pair of diagonal zippers located near the wheels of the bicycle. The zippers are attached in specific locations upon the cover to allow for the mounting and securing of the bicycle without removing the cover while utilizing a locking chain or similar locking device. The elastic at the bottom of the cover is positioned to draw the cover tight against the bicycle to prevent the cover from blowing off the bicycle. The cover is preferably devised of a lightweight, washable, durable, water resistant material, which material is preferably also a stretchable, form fitting material such as Spandex or Lycra. The cover covers the bicycle to protect the bicycle from the elements, thereby minimizing the wear and tear on the bicycle and adding to its useful life.

### IMPORTANT OBJECTS AND ADVANTAGES

The following important objects and advantages of the present invention are:

(1) to provide a bicycle protective cover for protecting the bicycle from the weather elements that can cause corrosion or other damage to the handlebars, frame, seats, chain, spokes and brakes;

(2) to provide a bicycle protective cover that protects the bicycle from the elements while still being able to securely lock up the bicycle;

(3) to provide a bicycle protective cover that protects the bicycle from the elements while still being able to transport the bicycle without having to remove the cover;

(4) to provide a bicycle protective cover that protects the bicycle from the elements while still being able to load the bicycle on a rack on a vehicle without having to remove the cover;

(5) to provide a bicycle protective cover that has pairs of zippers aligned so that locking devices can be inserted through the entire width of the cover;

(6) to provide a bicycle protective cover having zippers that are positioned at optimal locations for locking the bicycle;

(7) to provide a bicycle protective cover that contains pairs of horizontal zippers adjacent the crossbar of the bicycle and pairs of diagonal zippers adjacent the wheels of the bicycle;

(8) to provide a bicycle protective cover that utilizes an approximately one inch thick elastic segment at the bottom of the cover in order to provide a more snuglike, form fitting closing of the cover at the bottom;

(9) to provide a bicycle cover that cannot be easily removed from the bicycle and stolen; and

(10) to provide a bicycle cover device that will overcome the disadvantages of the prior art.

### BRIEF DESCRIPTION OF THE DRAWINGS

FIG. 1 is a side view of the bicycle cover of the present invention shown with a bicycle;

FIG. 2 is an upper perspective view of the bicycle cover of the present invention shown with a bicycle;

FIG. 3 is a perspective view of a pack that the bicycle cover of the present invention can be stored in;

FIG. 4 is an upper perspective view of an alternative embodiment of the present invention; and

FIG. 5 is a side view of the alternative embodiment of the present invention.

### DETAILED DESCRIPTION OF THE PREFERRED EMBODIMENT

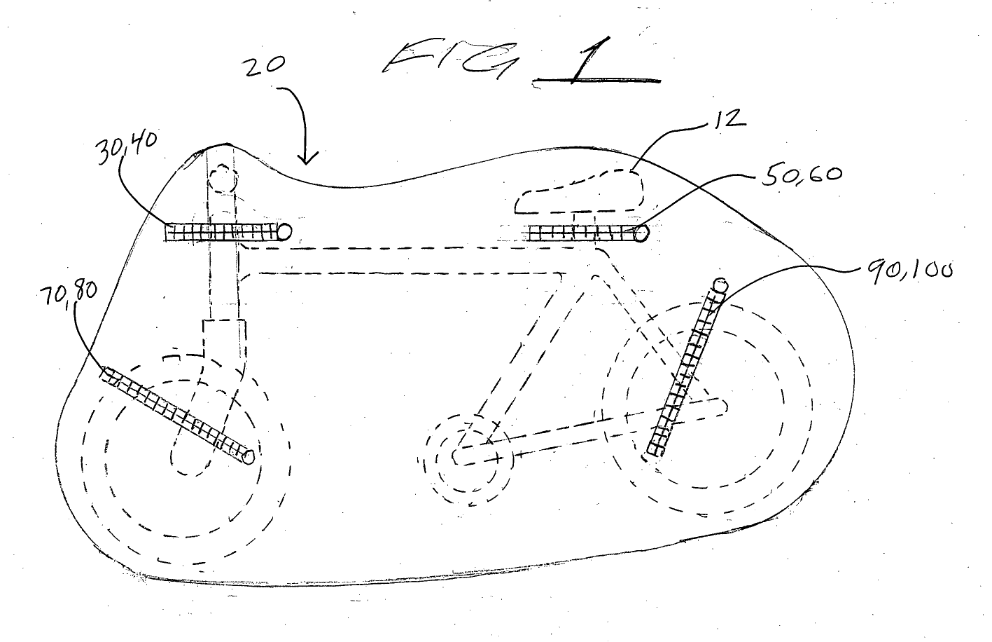

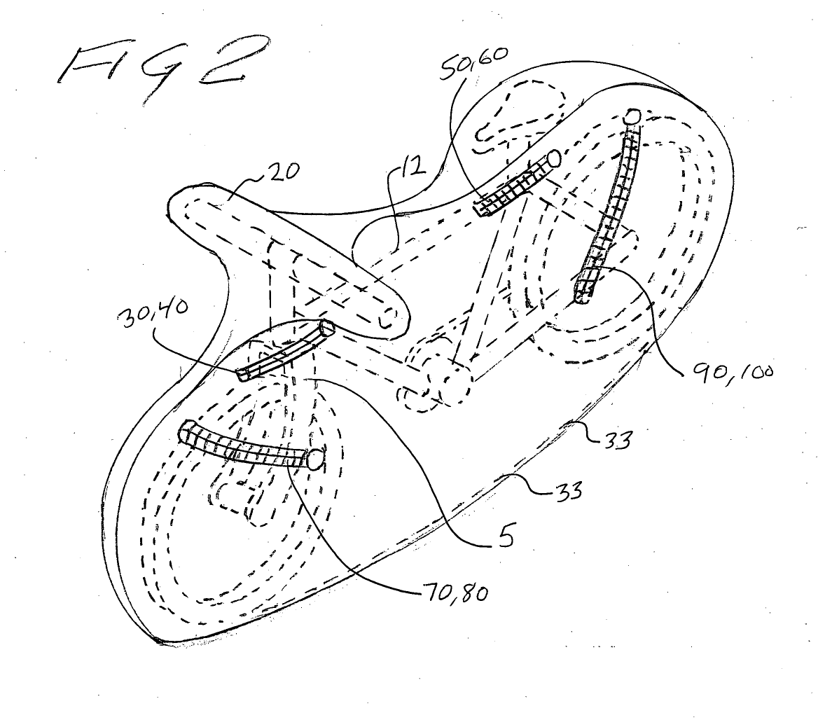

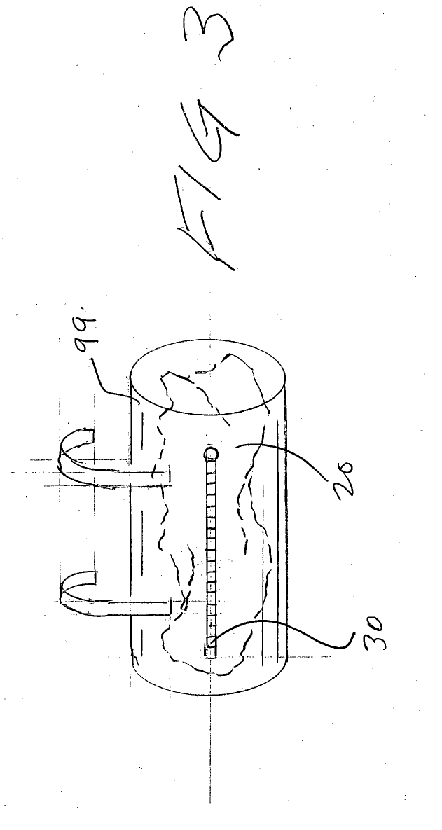

The apparatus of the present invention will now be illustrated by reference to the accompanying drawings. FIGS. 1 through 3 illustrate a bicycle protective cover 20 and a holder 99 for same. As explained below, the zippers in each zipper pair within cover 20 are aligned with one another. Hence, in FIGS. 1 and 2 each pair of zippers is depicted by a single zipper-object. It is understood that each such zipper-object depicted represents an actual pair of zippers rather than a single zipper. In the side view of FIG. 1, for example, the second zipper in each pair of zippers would in any event not be visible. Even in the perspective view of FIG. 3, however, while it may or may not be the case that both zippers in each pair of zippers would be visible in this drawing, both the first and the second zipper of each pair of zippers are represented by the single zipper-object shown in the drawing.

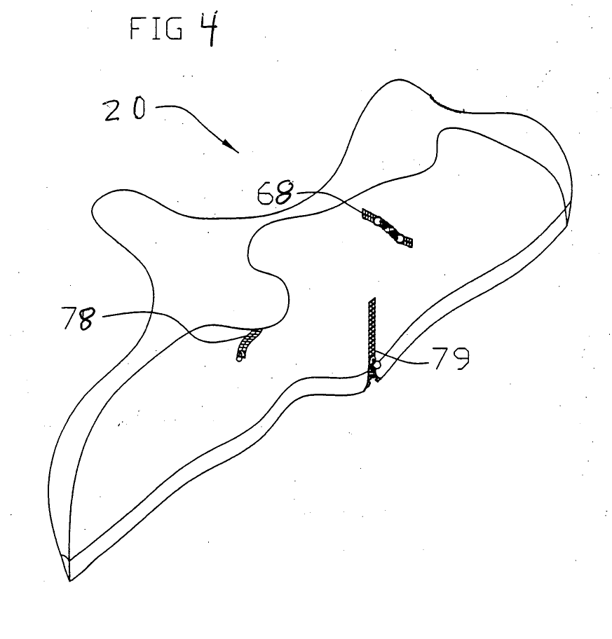

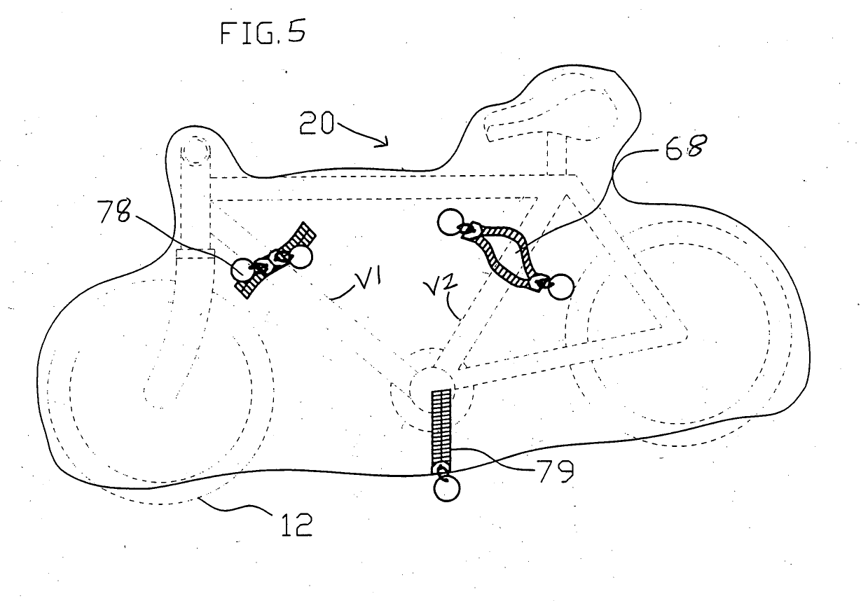

FIGS. 4-5 illustrate an alternative embodiment of the bicycle protective cover.

As seen in FIGS. 1-3, a bicycle protective cover comprises a cover 20 having at least one pair of zippers 30, 40, 50, 60, 70, 80, 90, 100 (and in certain embodiments up to four pairs of zippers 30, 40, 50, 60, 70, 80, 90, 100) for allowing locking chains or similar devices to be inserted through the cover 20 for securing the bicycle 12. The zippers 30, 40, 50, 60, 70, 80, 90, 100, sometimes called the “at least one pairs of zippers”, are attached in specific locations upon the cover 20 to allow for the mounting and securing of the bicycle 12 without removing the cover 20 while utilizing a locking chain or similar locking device.

In the embodiments where there are eight zippers comprising the at least one pair of zippers 30, 40, 50, 60, 70, 80, 90, 100 such zippers come in four pairs positioned in strategic locations. For example, the two front horizontal zippers 30, 40 are aligned so that chains and other similar devices can be inserted through the width of the cover 20. Similarly, the two rear horizontal zippers 50, 60 are aligned so that chains and other similar locking devices can be inserted through the width of the cover 20. The two front diagonal zippers 70, 80 are aligned so that chains and other similar locking devices can be inserted through the width of the cover 20 and the two rear diagonal zippers 90, 100 are aligned so that chains and other similar locking devices can be inserted through the width of the cover 20.

The pair of front horizontal zippers 30, 40 and the pair of rear horizontal zippers 50, 60 are typically approximately six inches long. Front horizontal zippers 30, 40 are situated near or substantially at the front of the bicycle crossbar (one zipper of the pair of front horizontal zippers 30, 40 on each side of the bicycle) the two zippers 30, 40 being aligned so that one can slip a lock through the entire width of the cover. Rear horizontal zippers 50, 60 are situated near or substantially at the rear of the crossbar (one zipper of the pair of rear horizontal zippers 50, 60 on each side of the bicycle), the two zippers 50, 60 being aligned so that one can slip a lock through the entire width of the cover.

It should be noted that while the pair of front horizontal zippers 30, 40 and rear horizontal zippers 50, 60 are preferably exactly parallel to the crossbar of the bicycle, there may of course be some deviation in direction or angle between the crossbar and the front and/or rear horizontal zippers 30, 40, 50, 60.

The pair of front diagonal zippers 70, 80 and the pair of rear diagonal zippers 90, 100 are typically approximately nine inches long. The front diagonal zipper pair 70, 80 is situated where the front wheel meets the fork (one zipper of the pair of front diagonal zippers 70, 80 on each side of the bicycle), the two front diagonal zippers being aligned so that one can slip a lock through the entire width of the cover. The rear diagonal zipper pair 90, 100 is situated where the rear wheel meets the bicycle gears, i.e. at approximately the center of the rear wheel (one zipper of the pair of rear diagonal zippers on each side of the bicycle) the two rear diagonal zippers being aligned so that one can slip a lock through the entire width of the cover.

The four diagonal zippers 70, 80, 90, 100 are preferably at 45 degree angles to the horizontal zippers 30, 40, 50, 60 but other angles are contemplated as long as the front and rear diagonal zippers 70, 80, 90, 100 are substantially diagonal when looked at from a side of the bicycle cover 20.

As used above, the term “fork” refers to the fork-like metal structure that connects the crossbar to the front wheel and which consists of a trunk or main bar extending from the crossbar and having two prongs that extend from the trunk and surround a portion of the top of the front wheel.

As described, the pairs of horizontal zippers 30, 40, 50, 60 and the pairs of diagonal zippers 70, 80, 90, 100 are positioned so as to be adjoining portions of the bicycle 12 most commonly used to lock the bicycle so that the convenience and safety of locking the bicycle through cover 20 is optimized.

The cover 20 is preferably devised of a lightweight, washable, durable, stretchable, form fitting, water resistant material such as spandex or Lycra. An elastic segment 33 (see FIG. 2) along the bottom of cover 20 helps to snugly close the cover 20. The cover 20 covers the bicycle 12 to protect the bicycle 12 from the elements, thereby minimizing the wear and tear on the bicycle while adding to the useful life of the bicycle 12. Cover 20 can be made of various colors and textures of material. Ornamental designs may also be utilized upon the cover 20 as desired by the user.

Cover 20 is constructed to completely or partially surround the bicycle 12. The cover 20 is designed to fit various shapes, sizes and designs including mountain bikes, road bikes and various other bicycles. Although FIG. 1 depicts the cover 20 from one side, the view from the other side is substantially the same.

The at least one pair of zippers 30, 40, 50, 60, 70, 80, 90, 100 allow the insert locking devices through the cover 20 about the bicycle 12 thereby preventing cover 20 from being accidentally removed or stolen. Zippers 20, 30, 40, 50, 60, 70, 80, 90, 100 are typically one way zippers. In an alternative embodiment some or all of zippers 20, 30, 40, 50, 60, 70, 80, 90, 100 may be two-way zippers having a two-way zipper structure. In either case, the zippers allow the insertion of a locking device to secure bicycle 12 to a structure such as a pole, tree or bike rack.

In the alternative embodiment shown in FIGS. 4-5, where the zippers are two-way, the two-way zipper structure of zippers 68, 78, 79 can be opened centrally to allow the locking device to be properly positioned to the frame of the bicycle 12. The alternative embodiment depicted in FIGS. 4 and 5 has zippers 68, 78, 79 that have a two-way zipper structure and that are positioned at three locations, which locations are different locations than the locations of the zippers used in the main embodiment. For example, two-way zipper 68 is positioned in a rear portion of the cover below the crossbar near a first leg V1 of the “V” that extends the bicycle frame below the crossbar, two-way zipper 78 is positioned in a front portion of the bicycle cover below the crossbar near the second leg V2 of that “V” and two-way zipper 79 is positioned in a lower portion of the cover.

It is contemplated by the present invention that the bicycle protective cover 20 allows for variations in size, materials, shape, form, function and manner of operation, assembly and use and that this is deemed to be within the expertise of those skilled in the art. Equivalent structural variations and relations to those illustrated in the drawings and described in the specification are intended to be encompassed by the present invention.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

1. A bicycle protective cover for fitting about a bicycle, comprising:
a cover for fitting about said bicycle;
at least one pair of horizontal zippers positioned within said cover, each zipper of a pair of the at least one pair of horizontal zippers being aligned with one another so that a locking device can be inserted through an entire width of the cover,
at least one pair of diagonal zippers positioned within said cover, each zipper of a pair of the at least one pair of diagonal zippers being aligned with one another so that a locking device can be inserted through an entire width of the cover.

2. The bicycle protective cover of claim 1, wherein the at least one pair of horizontal zippers includes a pair of front horizontal zippers and a pair of rear horizontal zippers.

3. The bicycle protective cover of claim 1, wherein the at least one pair of diagonal zippers includes a pair of front diagonal zippers and a pair of rear diagonal zippers.

4. The bicycle protective cover of claim 1, wherein the at least one pair of horizontal zippers is located near a bicycle crossbar.

5. The bicycle protective cover of claim 4, wherein a pair of front horizontal zippers is situated near a front of a bicycle crossbar and a pair of rear horizontal zippers is situated near a rear of a bicycle crossbar.

6. The bicycle protective cover of claim 1, wherein the at least one pair of diagonal zippers is located near the bicycle wheels.

7. The bicycle protective cover of claim 6, wherein a pair of front diagonal zippers is located near the front wheel and a pair of rear diagonal zippers is located near the rear wheel.

8. A bicycle protective cover for fitting about a bicycle, comprising:
a cover for fitting about said bicycle;
a first pair of zippers positioned within said cover, the first pair positioned within a rear portion of said cover, and
a second pair of zippers positioned within said cover, the second pair positioned within a front portion of said cover,
the zippers of the first pair of zippers being aligned with one another so that a locking device can be inserted through an entire width of the cover and the zippers of the second pair of zippers being aligned with one another so that a locking device can be inserted through an entire width of the cover.

9. The bicycle protective cover of claim 8, wherein the first pair of zippers and the second pair of zippers are horizontal.

10. The bicycle protective cover of claim 9, wherein the first pair of zippers is situated near a rear of a bicycle crossbar and the second pair of zippers is situated near a front of the bicycle crossbar.

11. The bicycle protective cover of claim 8, wherein the first pair of zippers and the second pair of zippers are diagonal.

12. The bicycle protective cover of claim 11, wherein the first pair of zippers is situated near the rear wheel and the second pair of zippers is situated near the front wheel.

13. The bicycle protective cover of claim 12, wherein the first pair of zippers is situated where the rear wheel meets the bicycle gears and the second pair of zippers is situated where the front wheel meets the fork.

14. A bicycle protective cover for fitting about a bicycle, comprising:
a cover for fitting about said bicycle;
at least one zipper positioned within said cover for allowing a locking device to be inserted therein to secure the bicycle, the at least one zipper including a first zipper positioned within a rear portion of said cover, the first zipper being comprised of a two-way zipper structure for receiving a locking device, the at least one zipper also including a second sipper positioned within a front portion of said cover.

15. The bicycle protective cover of claim 14, wherein the second zipper is comprised of a two-way zipper structure for receiving a locking device.
